(19) United States
(12) Patent Application Publication
(10) Pub. No.: US 2023/0376591 A1
(43) Pub. Date: Nov. 23, 2023

(54) METHOD AND APPARATUS FOR PROCESSING SECURITY EVENTS IN CONTAINER VIRTUALIZATION ENVIRONMENT

(71) Applicant: ELECTRONICS AND TELECOMMUNICATIONS RESEARCH INSTITUTE, Daejeon (KR)

(72) Inventors: Sung-Jin KIM, Daejeon (KR); In-Hyeok JANG, Daejeon (KR); Woo-Min HWANG, Daejeon (KR); Byung-Chul BAE, Daejeon (KR); Byung-Joon KIM, Daejeon (KR)

(21) Appl. No.: 17/953,498

(22) Filed: Sep. 27, 2022

(30) Foreign Application Priority Data
May 19, 2022 (KR) 10-2022-0061382

(51) Int. Cl. G06F 21/55; G06F 21/53

(52) U.S. Cl. CPC G06F 21/554; G06F 21/53; G06F 2221/034

(57) ABSTRACT

Disclosed herein is a method for processing a security event in a container virtualization environment. The method may include collecting designated security events in a kernel space, storing the collected security events in a security event storage module in real time, and providing a security manager with the security event corresponding to a query request from a security event management module, among the security events stored in the security event storage module.

### CROSS REFERENCE TO RELATED APPLICATION

This application claims the benefit of Korean Patent Application No. 10-2022-0061382, filed May 19, 2022, which is hereby incorporated by reference in its entirety into this application.

### BACKGROUND OF THE INVENTION

### 1. Technical Field

The present invention relates to a method and apparatus for processing security events in a container virtualization environment in order to monitor and control security events.

### 2. Description of Related Art

Generally, containers are widely used as base infrastructure for configuring microservices, Platform-as-a-Service (PaaS), and Software-as-a-Service (SaaS). Unlike existing hypervisor-based virtualization, container virtualization has a characteristic in which a host kernel is shared, and container escape, which can result from this characteristic, is recognized as a severe security threat.

“Container escape” indicates all kinds of behavior for accessing anything outside the boundary of allocated resources and privileges or the state in which such behavior is conducted, but from the aspect of a container host system, container escape may be regarded as a subset of vulnerabilities in an operating system (OS) kernel whereby privilege escalation becomes possible.

An attacker is assigned a container that can run with user privileges in a specific container host, acquires root privileges of the host by exploiting vulnerabilities in a shared kernel, installs a backdoor, and performs a series of attack activities, e.g., transfer of information to remote waypoints.

In order to respond to security threats in a container virtualization environment, conventional methods use security solutions such as Intrusion Prevention System (IPS) or Endpoint Detection and Response (EDR) solutions including a function of responding to abnormal behavior, but such conventional solutions have problems in that they do not recognize containers as targets to be separately managed and in that they are not specialized to support measures for responding to container-specific malicious behavior, such as container escape.

### SUMMARY OF THE INVENTION

An object of the present invention is to provide a method and apparatus for processing security events in a container virtualization environment in order to process security events in response to attack behavior of attackers in the container virtualization environment.

Another object of the present invention is to provide a method and apparatus for processing security events in a container virtualization environment such that security events related to containers can be read and managed.

In order to accomplish the above objects, a method for processing a security event in a container virtualization environment according to the present invention may include collecting designated security events in a kernel space, storing the collected security events in a security event storage module in real time, and providing a security manager with a security event corresponding to a query request from a security event management module, among the security events stored in the security event storage module.

The security events may include at least one of a containerized-process execution event, a network access event, or a privilege escalation event, or a combination thereof.

The method may further include further collecting argument values of a kernel routine and kernel data observed at an observation target point in the kernel space and controlling the security event by allowing or blocking the security event according to predefined rules based on information about whether the security event occurs, the argument values, and the kernel data.

The security events may be collected based on at least one of an LSM hook, a kprobe, or a tracepoint, or a combination thereof provided by an eBPF program.

Collecting the security events may include making a setting to execute a kprobe provided by an eBPF program, executing a target container process to be monitored, storing the status value of the target container process, and detecting a privilege escalation event by comparing the status value of the target container process with a previously stored reference value.

When the status value of the target container process is less than the previously stored reference value, it may be determined that privilege escalation is attempted, and a kill signal may be sent to the target container process.

Collecting the security events may include making a setting to execute an LSM hook provided by an eBPF program, executing a target container process to be monitored, extracting information about an executed file from a linux_binprm structure and extracting a hash value of the executed file in the information about the executed file, and determining whether the target container process is a malicious file by comparing the hash value with each of hash values registered in a blacklist.

When it is determined that the target container process is a malicious file, a return value other than 0 may be transferred to the target container process, whereby execution of the target container process may be stopped.

When it is determined that the target container process is not a malicious file, a return value may be transferred to the target container process.

After the return value is transferred to the target container process, the LSM hook may be terminated.

Also, an apparatus for processing a security event in a container virtualization environment according to an embodiment includes memory for storing a control program for processing a security event and a processor for executing the control program stored in the memory. The processor may collect designated security events in a kernel space, store the collected security events in real time, and provide a security event corresponding to a query request, among the stored security events.

The security events may include at least one of a containerized-process execution event, a network access event, or a privilege escalation event, or a combination thereof.

The processor may further collect argument values of a kernel routine and kernel data observed at an observation target point in the kernel space and control the security event so as to allow or block the security event according to predefined rules based on information about whether the security event occurs, the argument values, and the kernel data.

The security events may be collected based on at least one of an LSM hook, a kprobe, or a tracepoint, or a combination thereof provided by an eBPF program.

The processor may make a setting to execute a kprobe provided by an eBPF program, execute a target container process to be monitored, store the status value of the target container process, and detect a privilege escalation event by comparing the status value of the target container process with a previously stored reference value.

When the status value of the target container process is less than the previously stored reference value, the processor may determine that privilege escalation is attempted and perform control to send a kill signal to the target container process.

The processor may make a setting to execute an LSM hook provided by an eBPF program, execute a target container process to be monitored, extract information about an executed file from a linux_binprm structure, extract a hash value of the executed file in the information about the executed file, and perform control so as to determine whether the target container process is a malicious file by comparing the hash value with each of hash values registered in a blacklist.

When it is determined that the target container process is a malicious file, the processor may transfer a return value other than 0 to the target container process, thereby performing control to stop execution of the target container process.

When it is determined that the target container process is not a malicious file, the processor may perform control to transfer a return value to the target container process.

After transferring the return value to the target container process, the processor may perform control to terminate the LSM hook.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram illustrating a container-based application virtualization system according to an embodiment of the present invention;

FIG. 2 is a view illustrating the configuration of an apparatus for processing a security event according to an embodiment of the present invention;

FIG. 3 is a view illustrating an example of threat information expressed using STIX;

FIG. 4 is a flowchart illustrating a method for processing a security event according to an embodiment of the present invention;

FIG. 5 is a view illustrating an operation of detecting and controlling a security event according to an embodiment;

FIG. 6 is a view illustrating an example of a hook point and a probe/trace point for detecting and controlling a security event;

FIG. 7 is a view illustrating an operation of detecting and controlling an event based on kprobe according to an embodiment;

FIG. 8 is a flowchart illustrating a scenario in which a privilege escalation event is detected based on kprobe according to an embodiment;

FIG. 9 is a view illustrating an operation of detecting and controlling an event based on an LSM hook according to an embodiment;

FIG. 10 is a flowchart illustrating a scenario in which execution of a malicious file is detected based on an LSM hook according to an embodiment; and

FIG. 11 is a block diagram illustrating the configuration of a computer system according to an embodiment.

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only, and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

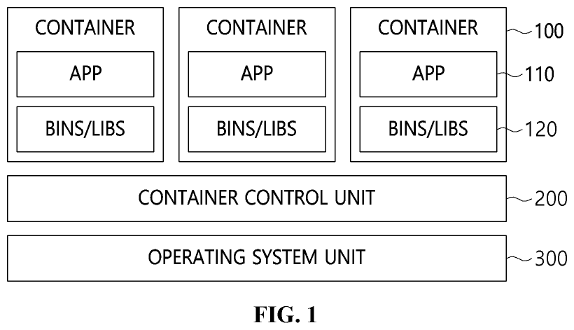

FIG. 1 is a block diagram illustrating a container-based application virtualization system according to an embodiment of the present invention.

Referring to FIG. 1, the container-based application virtualization system may include a virtual container 100, a container control unit 200, and an operating system unit 300.

The virtual container 100 may comprise multiple containers, and each of the containers 100 may include an application 110 and a registry 120.

The operating system unit 300 includes a host operating system installed in a virtual cloud server, and may provide the host operating system installed in the virtual cloud server to each of one or more constructed virtual containers 100. That is, the host operating system installed in the virtual cloud server may be the same as the operating system provided to the virtual container 100, or an operating system may be separately provided to the virtual container 100 by being installed in the virtual cloud server.

The container control unit 200 may include a container runtime (e.g., a Docker runtime), an orchestrator (e.g., Kubernetes), or the like.

When it executes a containerized application, the container control unit 200 may allocate a processor, a network, IPC, and a mount space for the application separately from the host using a namespace subsystem of a Linux system.

Also, the container control unit 200 may limit the system resources that can be used by an individual container 100 using a cgroups (control groups) subsystem. In addition, the operating environment may include toolchains, such as Clang or LLVM, or other compile tools for execution of an eBPF program.

The container control unit 200 is configured to control and manage one or more virtual containers 100 implemented on a virtual cloud server, and may detect and control security events. The container control unit 200 may have the structure of an apparatus for processing a security event in a container virtualization environment. Hereinafter, the container control unit is referred to as an apparatus for processing a security event.

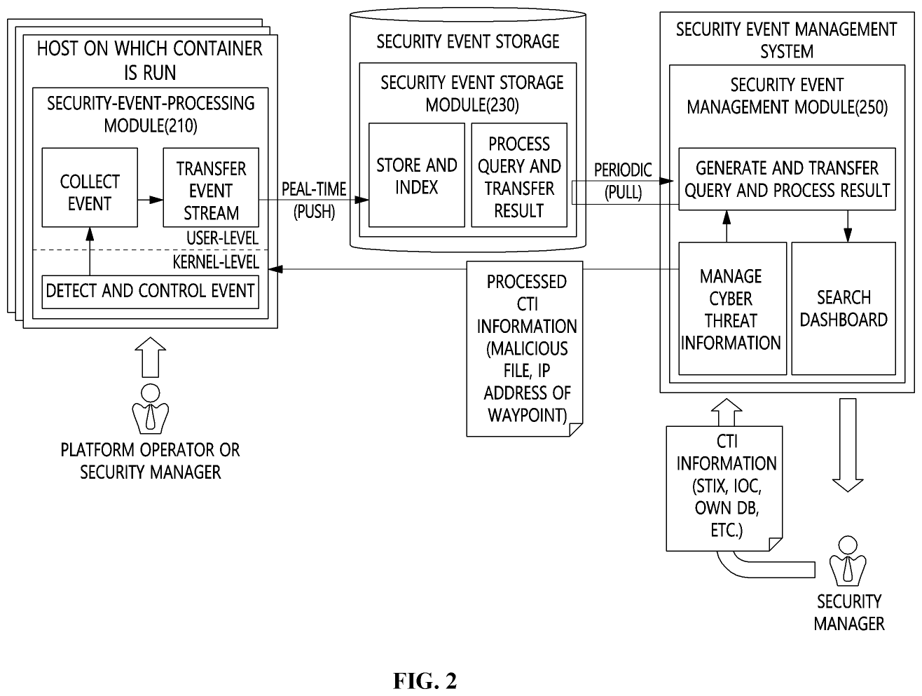

FIG. 2 is a view illustrating the configuration of an apparatus for processing a security event according to an embodiment of the present invention.

As illustrated in FIG. 2, the apparatus 200 for processing a security event according to an embodiment may include a security-event-processing module 210, a security event storage module 230, and a security event management module 250.

A host on which containers are run may include a container runtime for running containers, an orchestrator, and the like. The host on which containers are run may be configured with a larger number of physical systems (e.g., bare metal servers) or logical systems (e.g., virtual machines) than security event storage. The detection and control of a container security event may be performed at the level of the host shared kernel.

The security-event-processing module 210 may collect and control designated security events in the kernel of a target host.

The security-event-processing module 210 may check whether a security event occurs, and may collect the argument values of a corresponding kernel routine or kernel data observed at an observation target point of the kernel. The security-event-processing module 210 may allow or block the security event according to predefined rules based on information about whether a security event occurs, the argument values, and the kernel data. Here, the security event may include a containerized-process execution event, a network access event, a privilege escalation event, and the like.

The security-event-processing module 210 may transfer the allowed security event to the security event storage module 230 in real time. Here, the security event may be transferred to the security event storage module 230 using a data-processing pipeline service such as Logstash, Kafka, or OpenTelemetry.

The security event storage module 230 may store and index a security event. In response to a query request from the security event management module 250, the security event storage module 230 may provide the security event corresponding thereto to the security event management module 250. Here, the security event storage module 230 may use an Elasticsearch service, which performs data collection and indexing in real time in a distributed system environment.

The security event management module 250 may read security events stored in the security event storage module 230 and provide the same to a security manager. The security event management module 250 may extract threat information intended to be detected from external Cyber Threat Intelligence (CTI) information.

The security event management module 250 may generate a query for acquiring threat information, transfer the same to the security event storage module 230, and receive the result of the query. The security event management module 250 may use service such as Kibana, which provides a monitoring dashboard by operating in conjunction with a data pipeline service and a storage service.

The security manager may extract malicious IP addresses, the IP addresses of waypoints, the hash value of malicious code, and the like from the external Cyber Threat Intelligence (CTI) information, and may request the security event management module 250 to retrieve records matching the corresponding value from the security event storage module 230. The security manager may be provided with the requested security event from the security event management module 250.

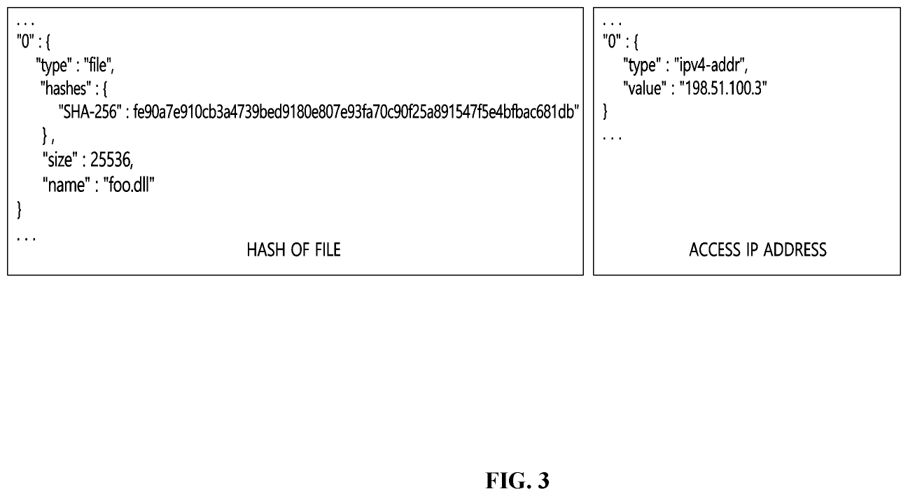

FIG. 3 is a view illustrating an example of threat information expressed using STIX.

As illustrated in FIG. 3, STIX may provide various object formats, including attack patterns, relevant malicious campaign information, malicious code information, observed data, and threat actor information.

A security manager may write indicators of threats using the formats and share the same.

The security event management module 250 in the embodiment may extract the hash value of a malicious file or IP address information of malicious waypoints from observed data and indicator objects in STIX 2.0 format, after which the security event management module 250 may generate a query to transfer to the security event storage module 230, or may transfer the processed CTI information to the security-event-processing module 210.

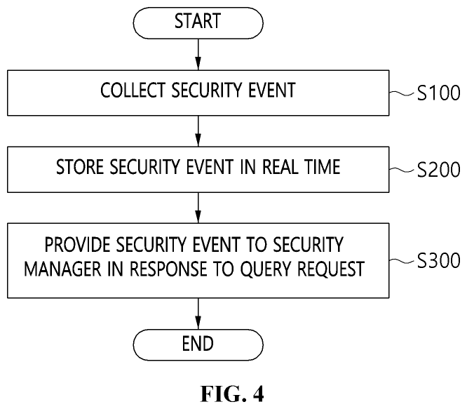

FIG. 4 is a flowchart illustrating a method for processing a security event according to an embodiment of the present invention. Here, the method for processing a security event may be performed by an apparatus for processing a security event.

Referring to FIG. 4, the security-event-processing module 210 may collect designated security events in a kernel space at step S100. The security-event-processing module 210 may allow or block the security event according to predefined rules based on information about whether a security event occurs, the argument values of a kernel routine, and kernel data observed at an observation target point of the kernel space.

The security event storage module 230 may store security events in real time at step S200. The security event storage module 230 may store and index the security events.

The security event management module 250 may generate a query in response to a request from a security manager and transfer the generated query to the security event storage module 230. The security event management module 250 may be provided with the security event corresponding to the query from the security event storage module 230 and provide the same to the security manager at step S300.

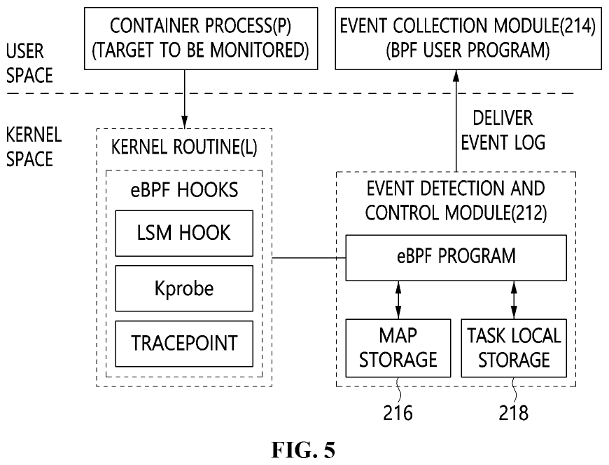

FIG. 5 is a view illustrating an operation of detecting and controlling a security event according to an embodiment.

As illustrated in FIG. 5, a security-event-processing module may include an event detection and control module 212 and an event collection module 214. The event detection and control module 212 may monitor the execution of a specific kernel function using a hook point or a probe/trace point provided by eBPF, or may control the execution of a specific kernel routine using an LSM hook. Here, an LSM point, kprobe, and Tracepoint may be used as a hook point, a probe, and a trace point, respectively.

The event detection and control module 212 may store the status value of a monitoring target process P at a specific time in map storage 216 and task local storage 218, and may check for changes in the status value.

The event detection and control module 212 may transfer a detected security event result to the event collection module 214, which is a BPF user program in a user space. The event detection and control module 212 may use a perf buffer, a ring buffer, or the like provided by the eBPF mechanism in order to transfer data.

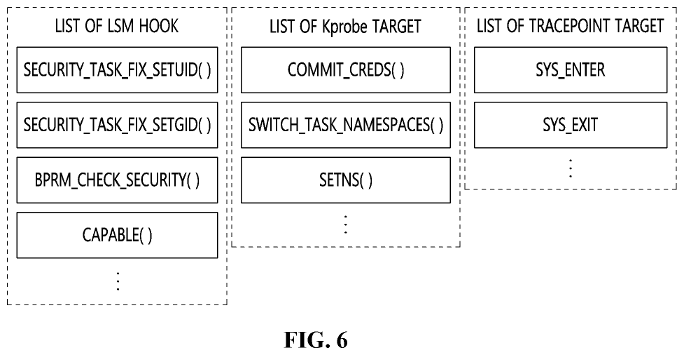

FIG. 6 is a view illustrating an example of a hook point and a probe/trace point for detecting and controlling a security event.

As illustrated in FIG. 6, when setuid( ) and setgid( ) which are system calls for changing uid and gid values, are called in order to adjust the privileges of a process, it can be seen that security hooks such as security_task_fix_setuid( ) and security_task_fix_setgid( ) are present in the corresponding kernel routine. An eBPF program monitors the event for changing the privileges of the target process by being attached to the corresponding LSM hooks, and may allow or block the event according to a predefined policy.

Also, the eBPF program sets a setns( ) system call as a probe target of kprobe, thereby monitoring an attempt to connecting the target process P to an already existing namespace.

The setns( ) system call may refer to a “proc/[pid]/ns/” link of a proc filesystem and select any of six namespace types (e.g., CLONE_NEWNS, CLONE_NEWUTS, CLONE_NEWIPC, CLONE_NEWPID, CLONE_NEWUSER, and CLONE_NEWNET). If the monitoring target process P attempts to connect the same to the namespace of the host on which the container is run using the setns( ) system call, this event may be regarded as malicious behavior for container escape.

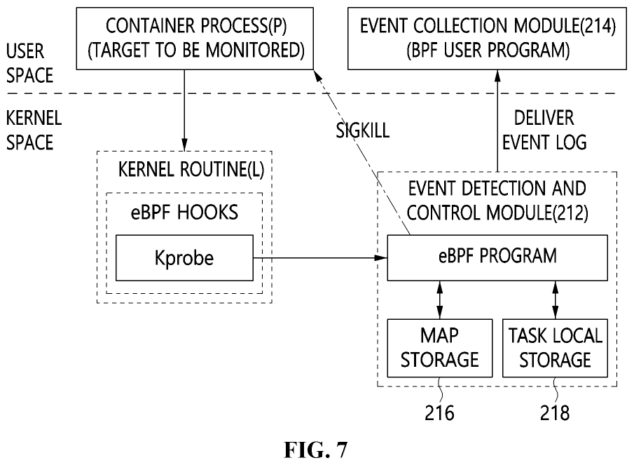

FIG. 7 is a view illustrating an operation of detecting and controlling an event based on kprobe according to an embodiment.

As illustrated in FIG. 7, the event detection and control module 212 may set a monitoring target kernel function and track a call of the function. When a call of the function violates a predefined policy, SIGKILL is sent to the monitoring target process P, whereby the container process is terminated and the malicious activity may be prevented from proceeding. This operation does not change the control flow of the kernel routine, and may be performed asynchronously.

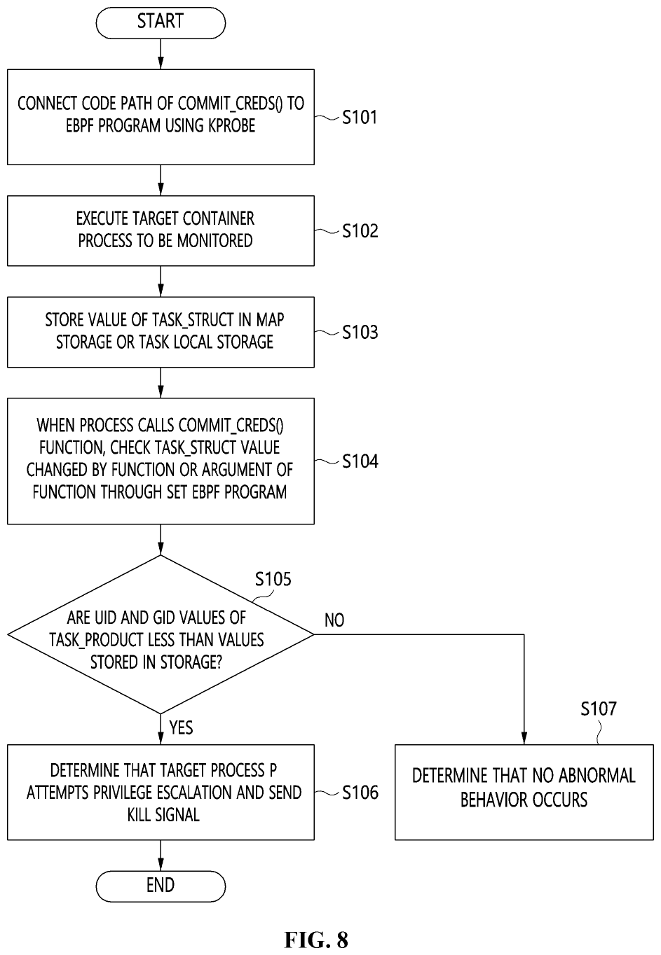

FIG. 8 is a flowchart illustrating a scenario in which a privilege escalation event is detected based on kprobe according to an embodiment.

An event detection and control module (pBPF program) 212 may be set so as to track a call of a commit_creds( ) function at step S101.

Subsequently, a target container process to be monitored may be executed at step S102. When the target container process to be monitored is executed, the current values of uid and gid of task_struct may be stored in map storage and task local storage at step S103. The commit_creds( ) kernel function may be executed multiple times during execution of the process.

When the commit_creds( ) function is called during execution of the process, the eBPF program may check the value of task_struct, which is the target to be changed by the commit_creds( ) function, at step S104. The values of uid and gid in the changed task_struct may be compared with the uid and gid values stored in the map storage or the task local storage at step S105.

When the values of uid and gid in the changed task_struct are less than the uid and gid values stored in the map storage or the task local storage, it may be determined that the process attempts malicious privilege escalation, so a SIGKILL signal may be sent to the process at step S106. Here, the uid and gid values stored in the map storage or the task local storage may be values that are stored when the process is executed.

Conversely, when the checked values of uid and gid are not less than the uid and gid values stored in the map storage or the task local storage, it may be determined that no malicious behavior occurs, and no special action may be performed at step S107.

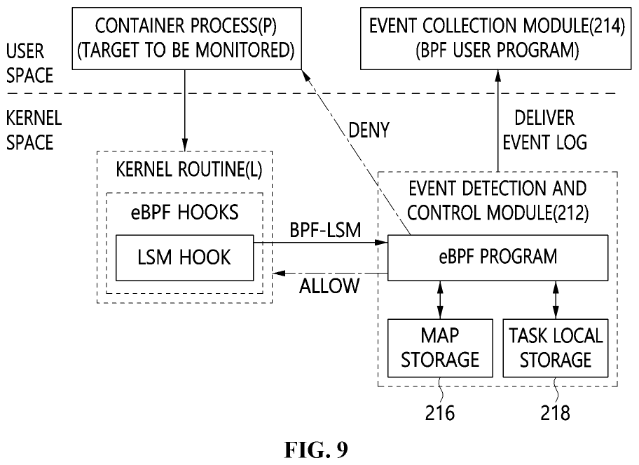

FIG. 9 is a view illustrating an operation of detecting and controlling an event based on an LSM hook according to an embodiment.

Referring to FIG. 9, the event detection and control module 212 monitors a specific kernel routine L by setting an LSM hook, and when a predefined policy is violated, the LSM hook returns an error such as EACCES or EPERM to the monitoring target process P so as to output ‘operation not permitted’ or to terminate the target process P, whereby malicious behavior is prevented from proceeding.

This operation is synchronously performed, and after the set LSM hook receives the control flow of the kernel routine L and performs the procedure included in the event detection and control module 212, it returns the control flow to the kernel routine L. Here, the routine may be interrupted by the procedure.

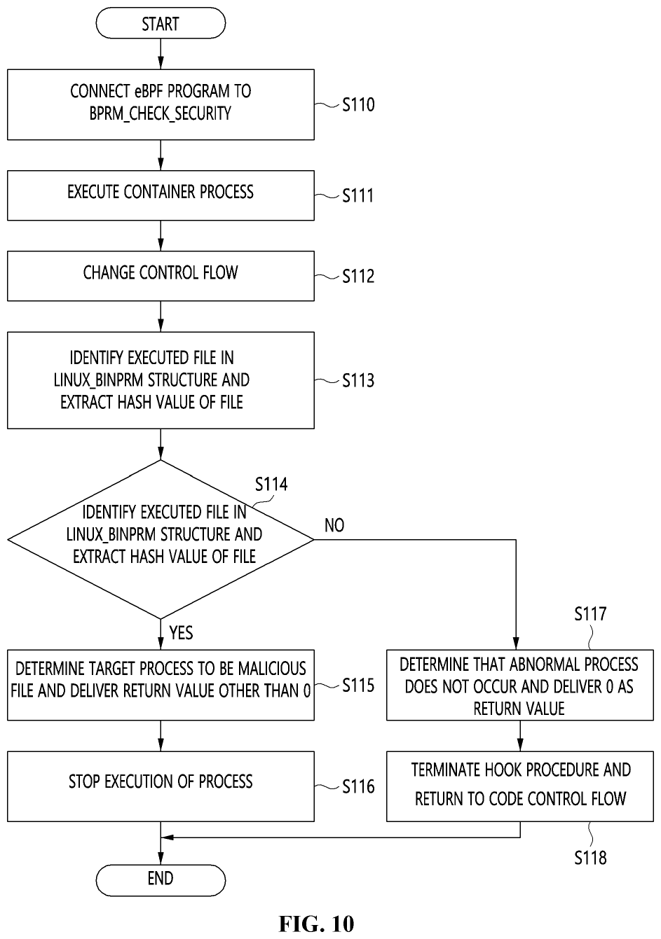

FIG. 10 is a flowchart illustrating a scenario in which execution of a malicious file is detected based on an LSM hook according to an embodiment.

As illustrated in FIG. 10, settings may be made such that the event detection and control module (eBPF program) executes an LSM hook in bprm_check_security( ) at step S110. Subsequently, a container process may be executed at step S111.

When the process is executed by calling a system call such as execve( ) execveat( ) or the like, the code control flow may be passed to the event detection and control module at step S112.

The event detection and control module may identify information about the executed file in a linux_binprm structure or the like, and may extract the hash value of the file at step S113. Then, whether the extracted hash value is equal to one of hash values registered in a blacklist may be determined at step S114. Here, the blacklist is assumed to be stored in map storage that can be directly accessed by the eBPF program.

When the hash value is equal to one of the values in the blacklist, the process is determined to be a malicious file, and EACCESS/EPERM may be transferred as a return value at step S115. Accordingly, execution of the process may be stopped at step S116.

Conversely, when the extracted hash value is not present in the blacklist, it is determined that malicious behavior does not occur, and 0 may be returned at step S117. Accordingly, the procedure of the event detection and control module is terminated, and control flow returns to the kernel routine, whereby the process may be executed normally at step S118.

The apparatus for processing a security event according to an embodiment may be implemented in a computer system including a computer-readable recording medium.

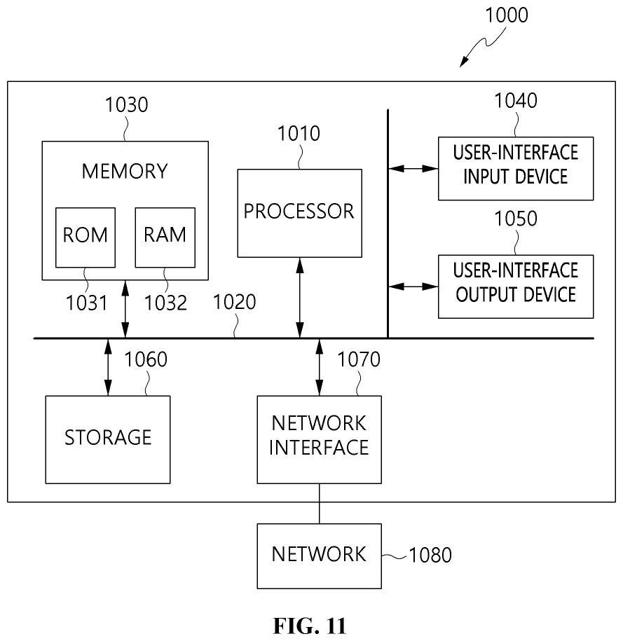

FIG. 11 is a block diagram illustrating the configuration of a computer system according to an embodiment.

Referring to FIG. 11, the computer system 1000 according to an embodiment may include one or more processors 1010, memory 1030, a user-interface input device 1040, a user-interface output device 1050, and storage 1060, which communicate with each other via a bus 1020. Also, the computer system 1000 may further include a network interface 1070 connected to a network.

The processor 1010 may be a central processing unit or a semiconductor device for executing a program or processing instructions stored in the memory or the storage. The processor 1010 is a kind of central processing unit, and may control the overall operation of the apparatus 200 for processing a security event.

The processor 1010 may include all kinds of devices capable of processing data. Here, the ‘processor’ may be, for example, a data-processing device embedded in hardware, which has a physically structured circuit in order to perform functions represented as code or instructions included in a program. Examples of the data-processing device embedded in hardware may include processing devices such as a microprocessor, a central processing unit (CPU), a processor core, a multiprocessor, an application-specific integrated circuit (ASIC), a field-programmable gate array (FPGA), and the like, but are not limited thereto.

The memory 1030 may store various kinds of data for overall operation, such as a control program, and the like, for performing a method for processing a security event according to an embodiment. Specifically, the memory may store multiple applications running in the apparatus for processing a security event and data and instructions for operation of the apparatus for processing a security event.

The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to an embodiment, the computer-readable recording medium storing a computer program therein may contain instructions for making a processor perform a method including an operation for collecting designated security events in a kernel space, an operation for storing the collected security events in a security event storage module in real time, and an operation for providing the security event corresponding to a query request from a security event management module, among the security events stored in the security event storage module, to a security manager.

According to the present invention, malicious behavior in a container, such as container escape, may be effectively detected and controlled in a container-based application virtualization environment.

Also, the present invention may improve the security of a container execution environment by detecting a security threat that can occur in a container runtime.

Although specific embodiments have been described in the specification, they are not intended to limit the scope of the present invention. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, corresponding components may not be absolutely necessary.

Accordingly, the spirit of the present invention should not be construed as being limited to the above-described embodiments, and the entire scope of the appended claims and their equivalents should be understood as defining the scope and spirit of the present invention.

What is claimed is:

1. A method for processing a security event in a container virtualization environment, comprising:
collecting designated security events in a kernel space;
storing the collected security events in a security event storage module in real time; and
providing a security manager with a security event corresponding to a query request from a security event management module, among the security events stored in the security event storage module.

2. The method of claim 1, wherein the security events include at least one of a containerized-process execution event, a network access event, or a privilege escalation event, or a combination thereof.

3. The method of claim 1, further comprising:
further collecting argument values of a kernel routine and kernel data observed at an observation target point in the kernel space; and
controlling the security event by allowing or blocking the security event according to predefined rules based on information about whether the security event occurs, the argument values, and the kernel data.

4. The method of claim 1, wherein the security events are collected based on at least one of an LSM hook, a kprobe, or a tracepoint, or a combination thereof provided by an eBPF program.

5. The method of claim 1, wherein collecting the security events includes:
making a setting to execute a kprobe provided by an eBPF program;
executing a target container process to be monitored;
storing a status value of the target container process; and
detecting a privilege escalation event by comparing the status value of the target container process with a previously stored reference value.

6. The method of claim 5, wherein, when the status value of the target container process is less than the previously stored reference value, it is determined that privilege escalation is attempted, and a kill signal is sent to the target container process.

7. The method of claim 1, wherein collecting the security events includes:
making a setting to execute an LSM hook provided by an eBPF program;
executing a target container process to be monitored;
extracting information about an executed file from a linux_binprm structure and extracting a hash value of the executed file in the information about the executed file; and
determining whether the target container process is a malicious file by comparing the hash value with each of hash values registered in a blacklist.

8. The method of claim 7, wherein, when it is determined that the target container process is a malicious file, a return value other than 0 is transferred to the target container process, whereby execution of the target container process is stopped.

9. The method of claim 8, wherein, when it is determined that the target container process is not a malicious file, a return value is transferred to the target container process.

10. The method of claim 9, wherein, after the return value is transferred to the target container process, the LSM hook is terminated.

11. An apparatus for processing a security event in a container virtualization environment, comprising:
memory for storing a control program for processing a security event; and
a processor for executing the control program stored in the memory,
wherein the processor collects designated security events in a kernel space, stores the collected security events in real time, and provides a security event corresponding to a query request, among the stored security events.

12. The apparatus of claim 11, wherein the security events include at least one of a containerized-process execution event, a network access event, or a privilege escalation event, or a combination thereof.

13. The apparatus of claim 11, wherein the processor further collects argument values of a kernel routine and kernel data observed at an observation target point in the kernel space and controls the security event so as to allow or block the security event according to predefined rules based on information about whether the security event occurs, the argument values, and the kernel data.

14. The apparatus of claim 11, wherein the security events are collected based on at least one of an LSM hook, a kprobe, or a tracepoint, or a combination thereof provided by an eBPF program.

15. The apparatus of claim 11, wherein the processor makes a setting to execute a kprobe provided by an eBPF program, executes a target container process to be monitored, stores a status value of the target container process, and detects a privilege escalation event by comparing the status value of the target container process with a previously stored reference value.

16. The apparatus of claim 15, wherein, when the status value of the target container process is less than the previously stored reference value, the processor determines that privilege escalation is attempted and performs control to send a kill signal to the target container process.

17. The apparatus of claim 11, wherein the processor makes a setting to execute an LSM hook provided by an eBPF program, executes a target container process to be monitored, extracts information about an executed file from a linux_binprm structure, extracts a hash value of the executed file in the information about the executed file, and performs control so as to determine whether the target container process is a malicious file by comparing the hash value with each of hash values registered in a blacklist.

18. The apparatus of claim 17, wherein, when it is determined that the target container process is a malicious file, the processor transfers a return value other than 0 to the target container process, thereby stopping execution of the target container process.

19. The apparatus of claim 18, wherein, when it is determined that the target container process is not a malicious file, the processor transfers a return value to the target container process.

20. The apparatus of claim 19, wherein, after transferring the return value to the target container process, the processor terminates the LSM hook.
